(19) United States
(12) Patent Application Publication
(10) Pub. No.: US 2005/0094566 A1
(43) Pub. Date: May 5, 2005

(54) Systems and methods for combining and extending routing protocols

(76) Inventor: Susan Hares, Saline, MI (US)

Correspondence Address: PERKINS COIE LLP, P.O. BOX 2168, MENLO PARK, CA, 94026, US

(21) Appl. No.: 10/966,075

(22) Filed: Oct. 14, 2004

Related U.S. Application Data
(60) Provisional application No. 60/511,281, filed on Oct. 14, 2003.
(60) Provisional application No. 60/511,404, filed on Oct. 14, 2003.

(51) Int. Cl. H04L 1/00

(52) U.S. Cl. 370/238; 370/255; 709/238

(57) ABSTRACT

Packet formats for routing protocols which combine link state and path vector routing techniques are described. Such protocols are referred to as Link State Path Vector (LSPV) protocols. Embodiments of the invention include extensions to protocols such as the Border Gateway Protocol (BGP) and Intermediate Standard to Intermediate Standard (IS-IS). Embodiments also include packet formats for LSPV protocols which align the bytes of the one or more LSPV protocols with bytes in formats for protocols in the prior art.

### CLAIM OF PRIORITY

This application claims priority to U.S. Provisional Application No. 60/511,281, filed Oct. 14, 2003, entitled “PACKET FORMATS FOR ADVANCED ROUTING PROTOCOLS” and U.S. Provisional Application No. 60/511,404, filed Oct. 14, 2003, entitled “OVERLAYING LSPV PACKETS ON ISIS, OSPF, AND BGP-4 PACKET HEADERS” each of which are hereby incorporated by reference in their entirety. This application is related to U.S. Utility Application No. 10/648,141, filed Aug. 25, 2003, entitled “ESTABLISHMENT AND ENFORCEMENT OF POLICIES IN PACKET-SWITCH NETWORKS”, U.S. Utility Application No. 10/648,146, filed Aug. 25, 2003, entitled “NESTED COMPONENTS FOR NETWORK PROTOCOLS,” and U.S. Utility Application No. 10/648,758, filed Aug. 25, 2003, entitled “SYSTEMS AND METHODS FOR ROUTING EMPLOYING LINK STATE AND PATH VECTOR TECHNIQUES,” each of which is hereby incorporated by reference in its entirety.

### TECHNICAL FIELD

This invention is related to the field of networking, and more particularly, to protocols and algorithms for routing in networks.

### BACKGROUND OF THE INVENTION

In communications networks such as the Internet, information is transmitted in the form of packets. A packet comprises a unit of digital information that is individually routed hop-by-hop on from a source to a destination. The routing of a packet entails that each node, or router, along a path traversed by the packet examines header information in the packet to compare this header against a local database; upon consulting the local database, the router forwards the packet to an appropriate next hop. This local database is typically called the Forwarding Information Base or FIB. The FIB is typically structured as a table, but may be instantiated in alternative formats. Entries in the FIB determine the next hop for the packet, i.e., the next router, or node, to which the respective packets are forwarded in order to reach the appropriate destination. The Forwarding information Bases are usually derived from global or network-wide information from a collective database. Each protocol names the collective databases to denote the type of information. Such databases are referred to generically herein as Network Information Bases (NIBs).

In implementations of the Internet Protocol (IP), the FIB is typically derived from a collective database, i.e., a NIB, referred to as a Routing Information Database or RIB. A RIB resident on a router amalgamates the routing information available to that router; one or more algorithms are typically used to map the entries, e.g., routes, in the RIB to those in the FIB, which, in turn, is used for forwarding packets to their next hop. The IP RIB may be constructed by use of two techniques, which may be used in conjunction: (a) static configuration and (b) dynamic routing protocols. Dynamic IP routing protocols may be further subdivided into two groups based on the part of the Internet in which they operate: exterior gateway protocols, or EGPs, are responsible for the dissemination of routing data between autonomous administrative domains, and interior gateway protocols, or IGPs, are responsible for dissemination of routing data within a single autonomous domain. Furthermore, two types of IGPs are in widespread use today: those that use a distance-vector type of algorithm and those that use the link-state method.

Route Selection Policies and EGPs

Routers typically support route selection policies which enable the identification of a best route amongst alternative paths to a destination. Routing selection policies may be pre-defined by a protocol, or may be otherwise distributed through a network, either statically or dynamically. An example of an EGP protocol which predefines route selection policies is exemplified by the Border Gateway Protocol version 4 (BGP-4), which allows route selection policy based on destination address and the BGP Path information. Routers also typically support route distribution policies, which govern the determination of which routes are sent to particular peers. Route distribution policies may be pre-defined by a protocol, statically configured, or dynamically learned. Dynamically learned policies can, in turn, be forwarded to a router within the same routing protocol, or, alternatively, forwarded via a separate protocol. As illustrative examples, BGP-4 allows for the inclusion of outbound route filter policies within BGP packets; the Rout Policy Server Language sends route distribution policy in a separate protocol. Some BGP-4 peers add or subtract BGP communities from e-BGP-4 path attributes, to mitigate policy processing on recipient peers. The addition of the BGP-4 Communities is sometimes called coloring of “dyeing” BGP-4 routes.

Link State Protocols

Link state routing protocols are typically based on a set of features uniquely tuned for each protocol. These features include:
The flooding link-state information.
Structure of link state information
Algorithms for computing a shortest path tree
Packets for communication.
Sub-protocols for neighbor acquisition and database synchronization, and

The sub-protocols for neighbor acquisition typically include indications for whether a link is up or down, and the creation of peer adjacencies. Extensions to the link state protocols are also available which allow for improved scaling. These extensions include:
Summarization of information within one level and area of the network for distribution into a higher level of routing process,
Expansion of information at higher level toward a lower level.

Examples of common link state protocols include OSPF and IS-IS. OSPF and IS-IS support two levels of hierarchy within the area of the network. Extensions to IS-IS in M-ISIS allow multiple Routing Information Bases (REIBs) with multiple level topologies be passed in the IS-IS protocol. Both the OSPF and ISIS protocols use a “hello” packet to signal that a peer is up on a link. A 2-way hello sequence between two peers involves the 1st peer sending a hello and the 2nd peer responding to the hello. A 3-way hello sequence between two peers involves the 1st peer sending a hello, the 2nd peer responding with a hello, and the 3rd peer responding with a third hello. Some hello sequences in other protocols (e.g., PLP) utilize a “heard-you” flag to indicate that the 2nd hello is in response to the first. Peer adjacency databases are generated per level per RIB, as are Shortest Path First (SPF) calculations; OSPF and ISIS utilize modified Dijkstra algorithms to compute shortest paths.

Path Vector Protocols

A prominent example of a path vector protocol is the Border Gateway Protocol, BGP v4. In this protocol, reachability information is passed from BGP-specific routers. Such reachability information may be inserted from Internal Gateway Protocols (IGPs), examples of which include OSPF, ISIS, RIP, IGRP or E-IGRP, an Exterior Gateway Protocol (EGP), which, in this case, is BGP, or static routes. BGP policy operates on the information contained in the route (for e.g., reachable prefix, AS Path, Path Attributes, NextHop router), the peer the route was received from, and the interface with which the route was associated. The Policy processing returns a metric that is associated with the route. Two routes first compare the two policy values to select the best route to be used. If the policy values are the same, the BGP protocol breaks ties between the two routes by comparison of the following:
1. AS Path length
2. Lowest origin,
3. Least value for the MED (if the MED is comparable)
4. Origin of: EGP 1st priority, IGP 2nd priority,
5. The route sent by a router with the least interior cost in the IGP,
6. Lower router-id of the peer sending the route,
7. The lowest neighbor address of the route.

Additionally, some implementations extend the BGP-4 specification to include the use the “time” of route creation for tie-breaking. The prior art evinces a need for routing techniques which combine features of link state and path vector protocols. There is also a need for such new techniques to be interoperable with existing internet infrastructure. These and other objectives are addressed by the invention described herein.

### SUMMARY OF THE INVENTION

This invention includes packet formats for routing protocols which combine link state and path vector routing techniques. Such protocols are referred to as Link State Path Vector (LSPV) protocols. Embodiments of the invention include extensions to protocols such as the Border Gateway Protocol (BGP) and Intermediate Standard to Intermediate Standard (IS-IS). Embodiments of the invention include packet formats for LSPV protocols which align the bytes of the one or more LSPV protocols with bytes in formats for protocols in the prior art. These and other embodiments of the invention are described in further detail herein.

### BRIEF DESCRIPTION OF THE DRAWINGS

FIG. 1 illustrates an overlay format for protocol headers in accordance with embodiments of the invention.

FIG. 2 illustrates an overlay format of Hello packet headers in accordance with embodiments of the invention.

### DETAILED DESCRIPTION OF THE INVENTION

Introduction: Link State Path Vector Protocols

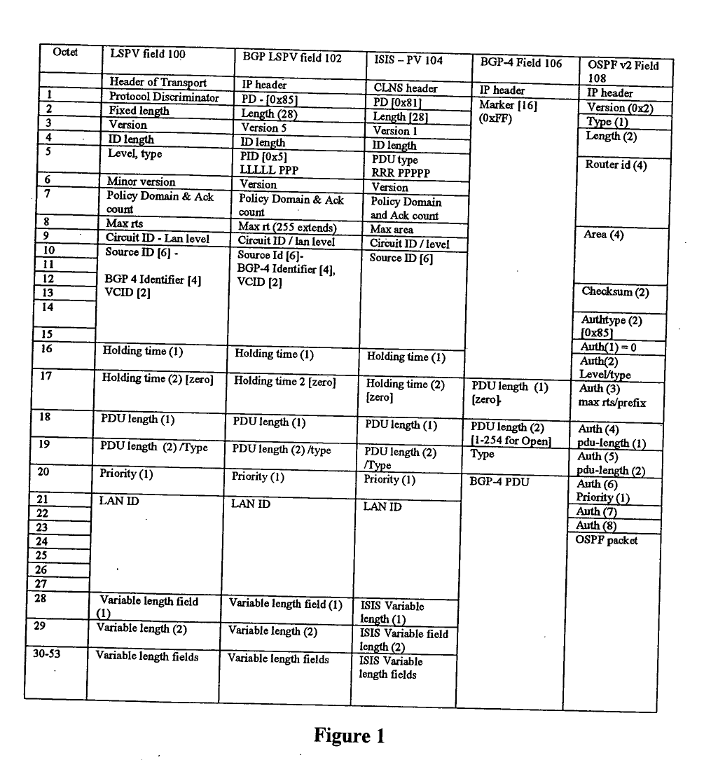

The concept of Link State Path Vector protocols is further described in U.S. utility application 10/648,758. LSPVs may include extensions to existing link state or path vector protocols. Embodiments of the invention include templates common to all LSPVs. Such embodiments include common formats for packet headers and PDUs, which may be overlayed over existing protocol formats. One such overlay format is illustrated in FIG. 1. FIG. 1 depicts a generic overlay template for LSPV protocols 100, and example formats for (1) LSPV extensions to BGP version 4 (BGP-4) 102, referred to herein as “BGP LSPV”, and (2) LSPV extensions to IS-IS 104, referred to herein as “IS-IS PV”. These header formats are shown alongside headers for two versions of the Open Shortest Path First protocol, OSPFv2 108 and OSPFv3 110, as well as BGP 4 106.

Table 1 below describes the individual fields in the LSPV header overlay 100.

TABLE 1

| Field Name | Length | # | Format | Description |
|---|---|---|---|---|
| [Intra-domain Routing | 1 octet | #1 | integer | architectural constant |
| Protocol Discriminator] | | | | [0x85] |
| [length indicator] | 1 octet | #2 | integer | fixed header length [30] |
| [Version/Protocol/ID] | 1 octet | #3 | integer | BGP version [5] |
| [ID length] | 1 octet | #4 | integer | ID field length |
| [level] [PDU type] | 1 octet | #5 | [LLLLL][PPP] | Level-type field |
| | | | | LLLLL - BGP Peer level |
| | | | | PPP - pdu type |
| [version] | 1 octet | #6 | bit-mask | Minor version/ack field |
| | | | | (Exact format depends on |
| | | | | PDU) |
| [Policy Domain/ack] | 1 octet | #7 | [LL DDDDDD] | Level ACK and |
| | | | | Policy Domain |
| | | | | [LL - level] |
| | | | | [DDDDDD - domain] |
| [maximum routes/prefix] | 1 octet | #8 | integer | max_rt |
| [PDU specific header] | n octets | | octets | format based on PDU type |
| | [9-53 octets] | | | and protocol |

In embodiments of the invention, LSPV protocols may include one or more of the following types of messages, or Packet Data Units (PDUs):
Hello PDUs
Link State PDUs
Complete Sequence Number Packets (CSNPs)
Partial Sequence Number Packets (PSNPs)
Policy filters
BGP-4 messages

These PDUs are elaborated upon further herein.

BGP LSPV

One extension of an existing path vector protocol to an LSPV, in accordance with embodiments of the invention, is an extension of BGP, referred to herein as BGP LSPV. In embodiments of the invention, BGP LSPV is a Link-State Path Vector protocol (LSPV) which utilizes a link-state algorithm to calculate the BGP peer topology over virtual links. The BGP Path Vector allows multiple paths for a BGP route weighted by a vector. The Path Vector portion of BGP utilizes routing policies to determine the vector of weights associated with each routes. In embodiments of the invention, the Link State Path Vector combines these two calculations for each route.

In embodiments, BGP LSPV peers are connected via a virtual link topology, which may or may not comprise full mesh topologies. BGP LSPV peers can be layered into multiple levels of Peer interconnection within a policy domain; a policy domain may comprise a single Autonomous System (AS) or multiple ASs, as further described in U.S. application Ser. No. 10/648,141, which is hereby incorporated by reference in its entirety. In embodiments of the invention, BGP LSPV peers can communicate as I-BGP peers with n-levels, or as I-BGP and E-BGP peers at n-levels within an Autonomous System Confederations, or as I-BGP and E-BGP at n-levels within a policy domain.

In embodiments of the invention, BGP LSPV establishes peer sessions with BGP-4 peers via TCP connections, or with other BGP LSPV peers via TCP connections, GRE Tunnels or Multicast groups within an Autonomous System (AS). In embodiments of the invention, these peers exchange one or more of the following types of packets:
Hello
Link State Packet (LSP)
Complete Sequence Number Packet (CSNP)
Partial Sequence Number Packet (PSNP)
Policy packets, and
BGP-v4 compatibility packets.

In embodiments of the invention, each of the packets has a fixed header and a variable amount of additional information following the PDU header. The variable information is formatted in Type-Length-Value (TLV) fields. Each TLV field may be in turn broken down into a variable length sub-TLV field. Each sub-TLV field may in turn be broken down into other sub-fields.

The Hello packets are used to establish a connection between BGP peers. The Link State Packet transmits data between two peers. The CSNP and PSNP are used to indicate which link state packets need to be resent to peers. The CSNP and PSNP allow flooding to resend any missed packets and to age out by flooding any over long packet. The Policy packets allow for BGP policy to be sent to a peer out of band from the normal Link State Packets. The BGP-v4 compatibility packet allows passage of the BGP LSPV packets.

Overlay of the Hello Header for All LSPV Protocols

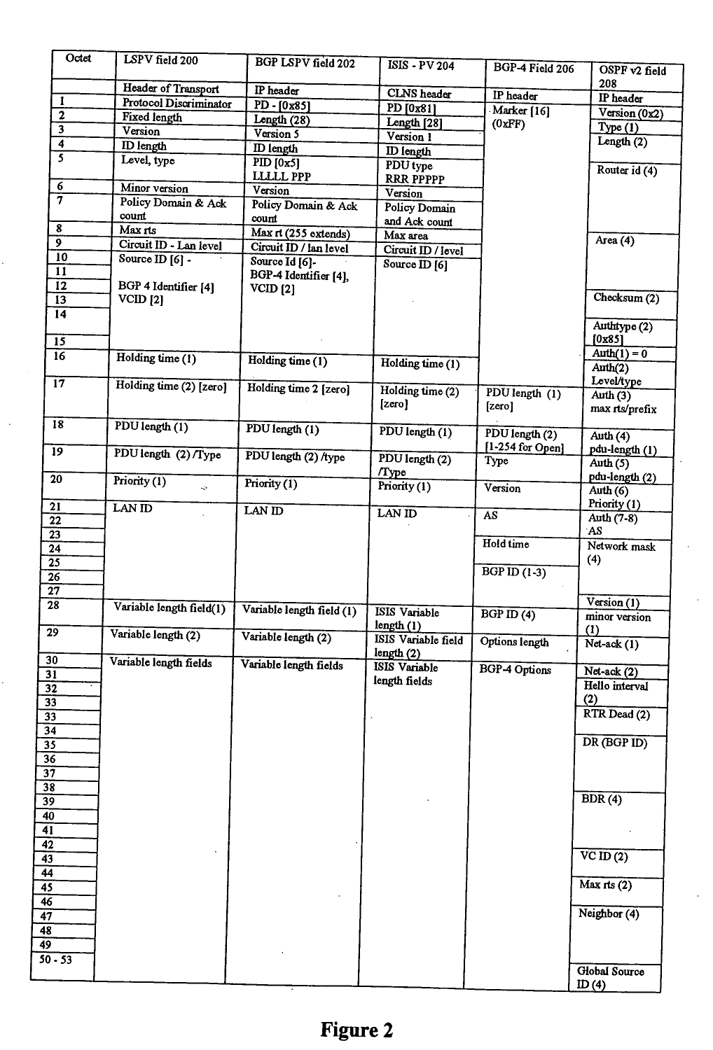

Embodiments of the invention include overlays for Hello messages in LSPV protocols. FIG. 2 illustrates overlay formats for hello PDUs in accordance with some embodiments of the invention. In particular, FIG. 2 illustrates an overlay template for Hello PDUs in LSPVs 200, alongside header formats for Hello PDUs in BGP LSPV 202, IS-IS LSPVs 204, and legacy protocols BGP 4 106, and OSPF 208 210, in accordance with embodiments of the invention.

Table 2 describes the individual fields of the overlay format for Hello messages in LSPV 200 in accordance with embodiments of the invention.

TABLE 2

| Field | length | # | Field format | Field definition |
|---|---|---|---|---|
| [Intra-domain Routing | 1 octet | #1 | integer | architectural constant |
| Protocol Discriminator] | | | | [0x85 - IDR protocol] |
| [length indicator] | 1 octet | #2 | integer | fixed length |
| [Version/Protocol/ID] | 1 octet | #3 | integer | BGP version [5] |
| [ID length] | 1 octet | #4 | integer | BGP ID length |
| [level] [PDU type] | 1 octet | #5 | [LLLLL][PPP] | Type-PDU field |
| | | | | LLLLL - level of BGP peer |
| | | | | PPP - 3 bits PDU type |
| | | | | PDU type = 1 |
| [version] | 1 octet | #6 | [HHHHAAAA] | Hello type, minor version |
| | | | | HHHH - hello type |
| | | | | AAAA - minor version ack |
| [Policy Domain/ack] | 1 octet | #7 | [LL DDDDD] | ACK count |
| | | | | LL = level |
| | | | | DDDDDD = ack count |
| | | | | 1-254 is valid range |
| [maximum routes/prefix] | 1 octet | #8 | integer | 1-254 = maximum number |
| | | | | of routes per prefix. |
| | | | | [255 = extended format] |
| [Circuit ID/level] | 1 octet | #9 | [000 000 LL] | [level bits] |
| | | | | LL = 00 - single level hello |
| | | | | LL = 01 - bit mask (0-4) |
| | | | | 10 - extended hello |
| | | | | 11 - reserved |
| [Source ID] | ID length | (#10-15) | | Source ID (6 octets) |
| | | | | BGP Peer Identifier - 4 bytes |
| | | | | VCID-[2 bytes] |
| [reserved/hold time] | 1 octet | #16 | [0000 0001] | reserved [0x01] or holding |
| | | | | time |
| [PDU length] | 2 octets | #17 | integer | PDU length in octets |
| [priority] | 1 octet | #19 | [R][PPPPPP] | priority |
| | | | | [R] - reserved |
| | | | | [PPP PPPP] - priority |
| LANID | 7 octets | (#20-27) | ID Length + 1 | LAN ID from ISIS |
| | | | | [1 Octet version |
| | | | | 2 octets AS |
| | | | | 2 octets Hold Time |
| | | | | 2 octets BGP ID (1-2) |
| Hold-time | 2 octets | #28 | BGP ID | 2 octets BGP ID (3-4) |
| Variable fields | n octets | (#28-up) | | variable information |

Variable Header Fields for Hello PDUs

In embodiments of the invention, the Hello PDU includes variable fields, which may, in turn, be used to transmit BGP parameters. In some embodiments, these parameters may include one or more of the following:

Standard Variable Fields:

Fixed header
Security TLV
   Optional Fariable Fields:
Data format
BGP ISIS Neighbor Addresses
BGP Neighbor Addresses
BGP Capability information
BGP Security
BGP LSP
BGP RIB IDs
BGP Peer Policy

In embodiments of the invention, these optional variable fields may be expanded upon as follows:
Data Format
Data format may specify one or more of the length of the IDs for BGP capabilities, AS path IDs, Policy metrics, Tie breaking info, and Label IDs. This field allows the expansion of the IDs into the bytes that fit the current format, after growth of the Internet address space. These formats allow BGP LSPV to be tailored to the minimum amount of space for a usage.

Embodiments of the invention may utilizes the following default format:

| ID field | length of field | PDU used in |
|---|---|---|
| BGP Peer | 4 octets | Hello, LSP |
| BGP Capability | 1 octet | Hello, LSP |
| BGP Security | 1 octet | Hello, LSP |
| BGP RIB ID | 1 octet | LSP |
| BGP Path ID | 4 octets | LSP |
| BGP Label | | |
| BGP AS Path | 3 octets | LSP |
| BGP MED | 1 octet | LSP |
| BGP Peer ID | 4 octets | LSP, Hello |
| BGP Capability ID | 1 octet | LSP, Hello |
| Security ID | 1 octet | LSP, Hello |
| BGP RIB ID | 1 octet | LSP, Hello |
| BGP Path Attribute | 4 octets | LSP |
| Label ID | 2 octets | LSP |
| Format ID | 1 octet | LSP, Hello |

BGP Peer's ISIS neighbor addresses
The ISIS addresses associated with BGP peer. These addresses may include one or more of the ISIS NET, interface addresses, and the network reachability addresses.
BGP Neighbor Addresses
The BGP Peer neighbor addresses are specified as BGP-Identifiers with associated link information (TCP or other).
BGP Capability Information
The BGP capability information may identify which BGP features this BGP-LSPV peer supports.
Security Information
BGP Security information associated with this BGP peer session. In the hello packet, security information can link to BGP-LSPV format information, BGP neighbor information or BGP Capability information.
In LSP information, the security information can apply any field in the PDU.
LSP Entries
LSP entries information that gives remaining life on LSP sent. LSP entry information is not valid in Hello or LSP packet. LSP entries are only valid in the Complete Sequence Number PDU or the Partial Sequence Number PDU.
RIB ID information
The RIB information associates a RIB ID with RIB information. The default format may include one or more of the following fields:
   RIB-id (1 octet), AFI (2 octets), SAFI (1 octet), Extended Communities field (count, communities (8 octets))
BGP Peer Policy
BGP peers can pass policy on which peers are accepted, and which links they will accept. This may include Peer addresses, capabilities of the peers, AS information, type of BGP protocol (BGP-4, BGP-LSPV or Both), type of peer (IBGP, EBGP, IBGP BGP-4 RR, IBGP BGP-4 RR client, IBGP BGP-4 AS confederation), capabilities of the peer (dynamic and static) including multi-protocol, route refresh and peer oscillation, and valid security associations. The “links” defmed can be TCP, GRE or other links. Each link may also set TE parameters.
In embodiments of the invention, BGP Peer policy is passed between IBGP peers to allow all IBGP peers to obtain the same policy. The BGP-LSPV protocol may either work with passing of BGP peer policy or via configuration for the BGP peer policy.
   Link State PDU

Embodiments of the invention include overlays for Link State messages in LSPV protocols. Table 3 lists field types in headers for link state messages in accordance with embodiments of the invention.

TABLE 3

| Field | length | Field format | Field definition |
|---|---|---|---|
| [Intra-domain Routing | 1 octet #1 | integer | architectural constant |
| Protocol Discriminator] | | | [0x85] |
| [length indicator] | 1 octet #2 | integer | fixed header length [28] |
| [Version/Protocol/ID] | 1 octet #3 | integer | BGP version [5] |
| [ID length] | 1 octet #4 | integer | ID field length [6] |
| [level] [PDU type] | 1 octet #5 | [LLLLL][PPP] | Level-type field |
| | | | LLLLL - BGP Peer level |
| | | | PPP - pdu type [2] |
| [version] | 1 octet #6 | [HHHHAAAA] | Minor version [1] |
| [Policy Domain/reserved] | 1 octet #7 | [LL PPPPPPP] | policy domain/level |
| | | | [LL - level |
| | | | PPPPPP - Policy Domain id |
| [maximum routes/prefix] | 1 octet #8 | integer | max routes per prefix |
| PDU length | 2 octets #9 | integer | pdu length |
| Remaining lifetime | 2 octets #11 | integer | # of seconds before expires |
| [LSP ID] | ID length + 2 | LSP-ID | BGPv4 Identifier [4 octets] |
| | (#13-20) | | VCID (high) [2 octets] |
| | | | LSP ID [2 octets] |
| Sequence number length | 4 octets | integer | sequence number of LSP |
| | #21-24 | | |
| [Checksum] | 2 octets | octets | checksum |
| | #25-26 | | |
| [Reserve/Overflow] | 1 octet | [RRRD][O][LL] | reserve/Overflow field |
| | #27 | | R - reserved, O - overflow |
| | | | LL - level (2 bits) |
| Variable fields | n octets | octets | variable fields |
| | #28-end | | |

In embodiments of the invention, Link State messages may further include one or more variable fields, examples of which are provided below:
Fixed header
Link State

In embodiments of the invention, Link State messages may also include one or more of the following optional headers:
Data format
BGP ISIS Neighbor Addresses
BGP Neighbor Addresses
BGP Capability information
BGP Security
BGP LSP
BGP RIB IDs
BGP Peer Policy
BGP Routes
BGP Path
BGP Labels
BGP Route Policy Results
BGP AS Path
BGP NextHop
BGP Local Communities
BGP Aggregator
BGP MISC
BGP Policy

In embodiments of the invention, these optional variable fields may be expanded upon as follows:
BGP Route Information
The BGP route information contains the following information. RIB-ID, Prefix, label-id, BGP Path-id, Policy results-id, Security ID field definitions allow grouping of prefixes by RIB-ID.
BGP Path Attributes
BGP path attribute information with:
BGP-Path-id is a tuple with a set of IDs. In embodiments, the default format may include one or more of the following:
BGP Path-ID, Origin ID AS Path-id, Next_Hop-id, Next_hop ID, MED_id, Aggregator_ID, Community_id, MISC_id
Label Attributes
MPLS label attributes associated with this path may also be communicated, in accordance with embodiments of the invention.
Policy Results
Includes policy information associated with BGP routes. In accordance with embodiments of the information included in the policy information may include one or more of the following:
   Policy-id:
   LOCAL_PREF info (received and calculated)
   MULTI_EXIT_DISC (received and calculated)
   Tie-break info (received and calculated)
   Policy-result-info[variable field]
   Policy-match-info (variable field)
AS Paths
This field contains a sequence of AS paths this BGP peer originates. Each of the AS path are identified by an AS Path ID of 4 bytes.
NEXT_HOPS
This field lists the NEXT_HOP information for a BGP peer.
Communities
This field contains BGP Communities information
Local Aggregation Attributes
This field contains the ATOMIC Aggregator and Aggregator information from a BGP Path.
Misc BGP4 Path Attributes
The local miscellaneous Path Attributes this BGP Peer originates such as, by way of non-limiting example, ATOMIC attributes or any optional transitive attributes not defmed by BGP-4 specifications.
Route Policy
Policy for BGP Routes Access lists, ORF lists, route maps and policy.
   Complete Sequence Number Packet

Embodiments of the invention support the communication of Complete Sequence Number Packets in LSPVs. In embodiments, the complete sequence number (CSN) packet indicate the life time, checksum and authentication of LSPs already sent. The CSN provides a range of information handled by this PDU.

An example format for CSN PDUs, in accordance with embodiments of the invention, is presented in Table 4.

TABLE 4

| Field | length | Field format | Field definition |
|---|---|---|---|
| [Intra-domain Routing | 1 octet #1 | | architectural constant |
| Protocol Discriminator] | | | [0x85] |
| [length indicator] | 1 octet #2 | | length of fixed header [17] |
| [Version/Protocol/ID] | 1 octet #3 | integer [5] | BGP version |
| [ID length] | 1 octet #4 | integer [6] | BGP ID length [6] |
| [level] [PDU type] | 1 octet #5 | [LLLLL][PPP] | level, pdu type [3] |
| [version] | 1 octet #6 | [HHHHAAAA] | Minor version |
| [Policy Domain/Ack] | 1 octet #7 | [LL DDDDDD] | Policy domain ack |
| [maximum routes/prefix] | 1 octet #8 | integer | 0-254 prefixes |
| PDU length | 2 octets #9 | | |
| [source ID] | ID length + | SRC-ID | BGP-ID [4 octets] |
| | 1 octets | | VCID-high [2 octets] |
| | (#11-17) | | zero [1 octet] |
| [start LSP ID] | ID length + 2 | | LSP-ID of 1st LSP |
| | (#18-#26) | | |
| [2nd LSP ID] | ID length + 2 | | LSP-ID of last LSP |
| | (#27-#34) | | |
| | (repeating of IDs) | | |
| . . . repeat here for LSPs | | | |
| [Last LSP ID] | ID length + 2 | | LSP-ID of Last ID |

In some embodiments, the LSP-ID format is as follows:
BGPv4 Identifier—4 octets
VCID—2 octets
LSP number—2 octets

This format of the LSP allows IS-IS and BGP v4 to run on the same connection as BGP-LSPV. Other suitable LSP ID formats shall be apparent to those skilled in the art.

In embodiments of the invention, CSN packets may include one or more variable fields. An example format for such variable fields is provided in Table 5.

TABLE 5

| Field | length | Field format | Field definition |
|---|---|---|---|
| Code | 1 octet | integer | Code point for type of field |
| Length | 1 octet | integer | length of the field |
| Value | length | variables | based on type |

Partial Sequence Number PDU

Embodiments of the invention allow Partial Sequence Number (PSN) messages to be communicated in LSPVs. An example of a format for such PSNs in accordance with embodiments of the invention is presented in Table 6.

TABLE 6

| Field | length | Field format | Field definition |
|---|---|---|---|
| [Intra-domain Routing | 1 octet #1 | [0x85] | architectural constant |
| Protocol Discriminator] | | | [0x85] |
| [length indicator] | 1 octet #2 | integer | length of fixed header [18] |
| [Version/Protocol/ID] | 1 octet #3 | integer | BGP version [5] |
| [ID length] | 1 octet #4 | integer | BGP ID length [6] |
| [level] [PDU type] | 1 octet #5 | [LLLLL][PPP] | level-type [5] |
| [version] | 1 octet #6 | [1] | Minor version |
| [Policy Domain/reserved] | 1 octet #7 | [LL DDDDD] | Policy Domain/acks |
| [maximum routes/prefix] | 1 octet #8 | integer | 0-254 prefixes |
| PDU length | 2 octets #9 | integer | length of PDU |
| [source ID] | ID length + | [source-id] | BGP Identifier length |
| | 2 octets | | VCID [2 bytes] |
| | (#11-18) | | |

In embodiments of the invention, PSNs may include variable fields, such as those presented in Table 7 below.

TABLE 7

| Field | length | Field format | Field definition |
|---|---|---|---|
| Code | 1 octet | integer | Type of TLV |
| Length | 1 octet | integer | length of the field |
| Value | length | variables | based on type |

Variable fields may also include one or more of the following:
LSP entries (type 4)
The LSP indicates remaining life, and a checksum
Security information (type 3)
The security information includes authentication information and security identifiers.
   PDU Format for Policy Filters

Embodiments of the invention support the communication of policy filters in LSPVs, which contain a complete sequence number PDU listing the IDs of all LSP sent by the given node. A header format used for such policy filters in accordance with embodiments of the invention is presented in Table 8.

TABLE 8

| Field | length | Field format | Field definition |
|---|---|---|---|
| [Intra-domain Routing | 1 octet #1 | [0x86] | architectural constant |
| Protocol Discriminator] | | | [0x85] |
| [length indicator] | 1 octet #2 | integer | length of fixed header |
| [Version/Protocol/ID] | 1 octet #3 | integer [5] | BGP version |
| [ID length] | 1 octet #4 | integer | BGP ID length |
| [level] [PDU type] | 1 octet #5 | [LLLLL][PPP] | level, type [type: 5] |
| [version] | 1 octet #6 | [HHHH AAAA] | Minor version |
| [Policy Domain/reserved] | 1 octet #7 | [LL PPPPPP] | Policy domain |
| [maximum routes/prefix] | 1 octet #8 | integer | 0-254 prefixes |
| PDU length | 2 octets #9 | integer | length of full pdu |
| Remaining lifetime | 2 octets #11 | integer | # of seconds before |
| expires | ID length + 2 | LSP-ID | BGPv4 Identifier [4 octets] |
| [LSP ID] | (#13-#20) | | VCID (high) [2 octets] |
| | | | Policy LSP ID [2 octets] |
| [Sequence number length] | 4 octets | integer | sequence number of LSP |
| | (#21-24) | | |
| [Checksum] | 2 octets | byte | checksum |
| | (#25-26) | | |
| [R] [RRD] [O] [LL] | 1 octet | [RRRD] [ORLL] | Overflow/reserved bit |
| | (#27) | | R - reserved, |
| | | | O - overflow bit |
| | | | LL - level (2 bits) |

In embodiments of the invention, the Policy Filter PDUs may include variable fields, which may include one or more of the following:
BGP Security
One of the two fields: BGP Peer Policy (TLV 7), BGP Route Policy
   Optional fields:
BGP Capabilities
BGP RIBs
BGP Peer Policy
BGP Route Policy
   BGPv4 Packet

In embodiments of the invention, BGP-LSPV can co-exist with a BGP-4 peer on the same packets. The BGP4 header includes 16 bytes of marker. The BGP-LSPV fixed header overlays the marker field of the BGP-4 packets. Currently the BGPv4 specification indicates that the marker bytes is all I s. In embodiments of the invention, the BGP-LSPV header allows for this marker field to be stuffed within it. In some such embodiments, , the intra-domain routing protocol Discriminator is set as 0×85 as an architectural constant for BGP-LSPV. 0×85 was used by IDRP, an ISO Version of BGP.

In embodiments of the invention, the header portion of the BGP-LSPV packets are the same format as the IS-IS packets with a 6 octet ID field and additional variable length fields at the end. The header portion of the BGP-LSPV packets can also overlay the maker field of the BGP-4 packets. These overlays provide BGP-LSPV with the ability to co-exist with either the BGP-4 or BGP-LSPV protocol on a link. The discriminating factor is the intra-domain routing protocol discriminator 0×85 that indicates this is a BGP-LSPV protocol.

In embodiments of the invention, the BGP-4 packets may initiate the connection with the following exchange:
Hello/Open [BGP LSPV hello/BGP v4 Hello]→
←—Hello/Open [BGP LSPV/BGP v4]
←BGP4/Keepalive [BGP LSPV/BGPv4]

In the event of a failure, in embodiments of the invention the BGP-4 may take down the connection with:
BGP4/Notify→

A PDU format for such headers, in accordance with embodiments of the invention, is presented in Table 9

TABLE 9

| Field | length | Field format | Field definition |
|---|---|---|---|
| [Intra-domain Routing | 1 octet #1 | | architectural constant |
| Protocol Discriminator] | | | [0x85 - IDR protocol] |
| [length indicator] | 1 octet #2 | integer | fixed length [28] |
| [Version/Protocol/ID] | 1 octet #3 | integer | BGP version [5] |
| [ID length] | 1 octet #4 | integer | ID length [6] |
| [level] [PDU type] | 1 octet #5 | [LLLLL][PPP] | Type-length [type 6] |
| [version] | 1 octet #6 | [HHHHAAAA] | Minor version |
| [Policy] | 1 octet #7 | | [reserved] |
| [maximum routes/prefix] | 1 octet #8 | 1-254 | maximum routes |
| | | | [255 = extended format] |
| [reserved/Circuit id] | 1 octet #9 | [000 000 11] | Level ID |
| | | | [1 = level bits] |
| [Source ID] | ID length | | Source ID (6 octets) |
| | #10-#15 | BGP ID | BGP Peer Identifier - 4 bytes |
| | | | VCID-[2 bytes] |
| [holding time] | 2 octets | integer | BGP-LSPV holding time |
| | #16-17 | | |
| [PDU length] | 2 octets | integer | PDU length in octets |
| | #18-19 | | |
| [priority] | 1 octet | integer | priority (7 bits) |
| | #20 | | [R] [PPP PPPP] |
| lanID | 7 octets | ID Length + 1 | LAN ID from ISIS |
| | #21-#27 | | [2 octets circuit/lan-id |
| | | | 2 octets BGP4 pdu length |
| | | | 1 octet BGP4 type |
| | | | 2 octets BGP4 info |

| Message | Field format | length | Field definition |
|---|---|---|---|
| Update [2] | BGP info | 2 bytes | # of withdrawn routes |
| Keepalive [3] | BGP info | 2 bytes | nothing |
| Notify[4] | BGP info | 2 bytes | 1 byte Error code |
| | | | 1 byte Error Sub-code |

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A computer network system for exchanging routing information in an inter-network, the system further including a link state path vector protocol for exchanging routes to destinations on the inter-network, wherein the routes are entered into link-state databases along with associated path vectors in order to select routes in the inter-network, and wherein packets exchanged via the link state path vector protocol are encoded in a prescribed format, the computer network system comprising:
a plurality of packet data unit (PDU) types exchanged via the link state path vector protocol, the plurality of PDU types including
hello PDUs for initiating communication sessions between routers exchanging routes via the link state path vector protocol,
link state PDUs indicating a set of adjacent routers in the inter-network;
a first plurality of contiguous octets in the prescribed format, the first plurality of contiguous octets including one or more fields indicating an length indicator, a version number, an identifier for a source router for packets communicated by the link state path vector protocol;
a second plurality of contiguous octets following the first plurality of contiguous octets, the second plurality of contiguous octets including one or more fields indicating an identifier for a local area network and a PDU length for packets communicated by the link state path vector protocol;
wherein the plurality of PDU types are formatted according to the prescribed format.

2. The computer network system of claim 1, wherein the first plurality of contiguous octets are aligned with a marker field in a header format for Border Gateway Protocol version 4.

3. The computer network system of claim 1, wherein the link state path vector protocol is an extension of Border Gateway Protocol (BGP).

4. The computer network system of claim 3, wherein the first plurality of contiguous octets includes a protocol discriminator field, the protocol discriminator field including a hexidecimal constant identifying the extension of Border Gateway protocol.

5. The computer network system of claim 4, wherein the hexidecimal constant equals 0×85.

6. The computer network system of claim 1, wherein the link state path vector protocol includes an extension to Intermediate System-Intermediate System (IS-IS).

7. The computer network system of claim 1, wherein the plurality of packet types further include Partial Sequence Number Packets.

8. The computer network system of claim 1, wherein the plurality of packet types further include Complete Sequence Number Packets.
the system including a first protocol for exchanging routing information, wherein the first protocol is one of a legacy link state protocol and path vector protocol,
complete sequence number PDUs indicating one or more of a lifetime, a checksum, and an authentication of routes exchanged

9. The computer network system of claim 1, wherein the plurality of PDU types further includes BGP Update messages.

10. The computer network system of claim 1, wherein the plurality of PDU types further includes BGP Keepalive messages.
